(19) United States
(12) Patent Application Publication
(10) Pub. No.: US 2017/0326941 A1
(43) Pub. Date: Nov. 16, 2017

(54) AIR VENT FOR ARRANGEMENT IN THE INTERIOR OF A MOTOR VEHICLE

(71) Applicant: GM GLOBAL TECHNOLOGY OPERATIONS LLC, Detroit, MI (US)

(72) Inventors: Thorsten FRENZEL, Ruesselsheim (DE); Torsten ZIMMERMANN, Ruesselsheim (DE)

(73) Assignee: GM GLOBAL TECHNOLOGY OPERATIONS LLC, Detroit, MI (US)

(21) Appl. No.: 15/591,858

(22) Filed: May 10, 2017

(30) Foreign Application Priority Data
May 10, 2016 (DE) 202016002952.6

(51) Int. Cl. B60H 1/00

(52) U.S. Cl. CPC B60H 1/00564; B60H 1/00464

(57) ABSTRACT

An air vent includes a longitudinally extending housing forming a flow channel and an insert extending across channel within the housing. A longitudinally extending hollow shaft is arranged on the insert and is movable in the housing. An actuating element is guided on the shaft in a longitudinally displaceable fashion. Slats are arranged on an outer side of the shaft, connected to the actuating element and arranged on the insert in an adjustable or movable fashion. The slat can be adjusted in different configurations or alignments in the flow channel such that the flow characteristic of the air vent, namely the intensity of the air mass flow and/or the direction of the air flow discharged from the air vent, can be varied.

### CROSS-REFERENCE TO RELATED APPLICATION

This application claims priority to German Patent Application No. 202016002952.6, filed May 10, 2016, which is incorporated herein by reference in its entirety.

### TECHNICAL FIELD

The present disclosure pertains to an air vent, particularly for arrangement in the interior of a motor vehicle.

### BACKGROUND

Multiple individually adjustable air vents, which are fluidically connected to a blower of a heating, ventilation and/or air-conditioning system, are typically arranged in the interior of a motor vehicle. Air vents are integrated, for example, into a dashboard. Such air vents typically are manually adjustable in order to vary the air flow passing through them in accordance with the desired intensity, outflow characteristic and/or direction. In order to achieve a particularly simple and intuitive control, it is desirable to minimize the number of actuating or control elements that are provided on an air vent and serve for adjusting the respectively desired intensity of the air flow, as well as its direction.

For example, DE 10 2007 019 602 B3 discloses an air vent with a nozzle housing and a manipulator, which features a stopper on the side facing an air intake opening of the nozzle housing. The stopper is in the axial direction formed by the manipulator and configured to covering an air intake opening in a form-fitting fashion.

### SUMMARY

The present disclosure provides an air vent with minimal actuating elements for adjusting the flow characteristic, as well as the flow direction. The air vent can be intuitively and easily controlled and has a particularly stylish design that can be integrated into the appearance of a dashboard in the interior of a motor vehicle as harmoniously as possible. In accordance with the present disclosure, it is possible to adjust and vary the direction, the intensity and the outflow characteristic of the air vent with only a single actuating or control element, making it possible to reduce the number of components in the air vent in comparison with known solutions.

In accordance with the present disclosure, an air vent includes a longitudinally extending housing that features a flow channel. An insert extending over the flow cross section of the flow channel is arranged within the housing. A longitudinally extending hollow shaft is provided or arranged on the insert, which may be designed movable relative to the housing. In a normal position of the insert on the housing, the shaft is typically aligned parallel to the longitudinal extent of the housing or parallel to the flow channel, respectively.

The air vent furthermore features an actuating element that is guided in or on the shaft in a longitudinally displaceable fashion. In addition, the air vent features at least one slat that is arranged on an outer side of the shaft and connected to the actuating element. The slat is respectively arranged on the insert in an adjustable or movable fashion. It is at least sectionally guided on the shaft in a longitudinally displaceable fashion, in particular, due to its connection to the actuating element. The slat can be arranged or adjusted in different configurations or alignments in the flow channel such that the flow characteristic of the air vent, the intensity of the air mass flow and/or the direction of the air flow discharged from the air vent can be varied.

At least two of the following parameters—air mass flow, outflow characteristic and/or direction of the air flow—can be adjusted as needed due to the way in which the actuating element is guided and coupled to the slat. The outflow characteristic of the air vent may be distinguished by a spatially fanned-out and comparatively wide and diffuse air flow or by a spatially focused or concentrated air flow.

The sliding displacement or translation of the actuating element in the shaft and its mechanical coupling to the slat make it possible to manipulate and vary at least two parameters—air mass flow, outflow characteristic or direction—by actuating a single actuating element. Consequently, multiple flow parameters concerning the outflow characteristic of the air vent can be varied as needed with only one actuating element.

According to another embodiment, the slat is supported on the shaft such that it can be moved between an open position and a closed position. In the open position, the slat almost completely rests against the outer side of the shaft. It preferably rests tightly against the outer side of the shaft in order to maximize the flow cross section of the flow channel, through which air can flow. In this case, the slat may extend, e.g., in the longitudinal direction of the shaft.

In the closed position, the slat protrudes from the shaft into the flow channel. The slat insofar reduces the flow cross section of the flow channel in the closed position. For example, the slat may largely close the entire flow cross section of the flow channel in its closed position. If the air vent is provided with only a single slat, this slat may be realized in the form of a shut-off or throttle flap of sorts, which in the closed position extends over the entire flow cross section of the flow channel. In the closed position, the slat is air-impermeable and blocks or throttles the air flow through the housing and the flow channel.

According to another embodiment, the air vent features multiple slats that are distributed over the outer circumference of the shaft. Each of these slats can be longitudinally displaced along the shaft between an open position and a closed position. In this case, each of the slats may be respectively connected or mechanically coupled to the actuating element. However, it is also conceivable that one or more slats are directly connected to the actuating element whereas other slats, which are not connected to the actuating element, can be moved between the open position and the closed position indirectly by the slats directly connected to the actuating element. For example, only two slats of a plurality of slats may be directly coupled to the actuating element mechanically. The slats, which are respectively realized air-impermeable, may in the closed position be arranged relative to one another in such a way that they fluidically close the entire flow cross section or a portion thereof. All slats may respectively rest against the outer side of the shaft in the open position.

In the open position, the slats preferably extend in the longitudinal direction of the shaft, i.e. in the axial direction. They have a minimum extent in the radial direction when they are in the open position. In the closed position, the slats have a maximum extent in the radial direction such that they block the largest portion of the flow cross section possible. In this context, it is proposed, for example, that the individual slats carry out a combined translation and rotation or pivoting motion during the course of a transfer from the open position into the closed position. For example, the individual slats are guided on the shaft in an axially displaceable fashion in the region of the connection or mechanical coupling to the actuating element.

The coupling or connection to the shaft may simultaneously serve as pivoting point or pivoting axis, about which the respective slat pivots between the open position and the closed position. The pivoting axis may extend, e.g., perpendicular to the axial direction. The pivoting axis may particularly extend tangentially or circumferentially to the hollow-cylindrical shaft. During the course of an opening motion, the pivoting axis of each slat likewise moves in the axial direction such that the respective slat consequently carries out a combined translation and rotary or pivoting motion.

When the slat or multiple slats respectively is/are in an intermediate position between the open position and the closed position, the slat or multiple slats can purposefully influence and vary the flow characteristic and, if applicable, also the direction of the air flow. When the slats are in their open position, for example radially central on the insert, and cover the smallest flow cross section possible, the entire flow channel can be acted upon with air in a largely homogenous fashion.

When the slats are transferred toward their closed position, for example, the flow cross section of the flow channel, through which air can flow, changes to an annular gap. The air mass flow and the outflow characteristic of the air vent can thereby be varied as needed. In this respect, it is possible to adjust a diffuse air flow in that the slats almost completely block or restrict the flow cross section, through which air can flow. In this way, the air mass made available by the heating, ventilation and air-conditioning module can be significantly decelerated, but nevertheless reach the vehicle interior. This can contribute to satisfying the demand of vehicle occupants for more air and for a comfortable thermal environment in the vehicle interior. Once the closed position is reached, the flow cross section typically is completely blocked by the slats transferred into the closed position.

According to an enhancement, the insert of the air vent features an outer ring that rests against an inner wall of the housing. The outer ring is realized in accordance with the geometry of the inner wall of the housing. The outer ring typically has a circular design and the inner wall has at least in the region of the outer ring a cylindrical shape, typically in the form of a cylindrical surface area. Referred to as a corresponding cylinder symmetry, the insert is radially supported on the inner wall of the housing by the outer ring.

The outer ring is typically realized in the form of a continuous and closed ring that furthermore provides the insert with a certain mechanical stability and strength.

According to another enhancement, the outer ring has a curved outer surface that is pivotably supported on a correspondingly shaped curvature section on the inner wall of the housing. The outer surface of the outer ring may also be realized in the form of a sphere or a spherical segment. Accordingly, the inner wall may in the region of the outer ring have a corresponding geometry in the form of a spherical segment or spherical socket. Viewed in the longitudinal direction and in a longitudinal cross-section, the outer surface of the outer ring may, for example, be curved in a convex fashion whereas the curvature section on the inner wall of the housing has a concave curvature corresponding thereto.

The corresponding surfaces of the outer ring and the inner wall, particularly the curved outer surface and the curvature section, make it possible to arbitrarily pivot the insert relative to the housing. Referred to as a spherical symmetry of the housing and the flow channel formed thereby, the insert therefore can be pivoted relative to the housing in any arbitrary radial direction. In this respect, the insert can be pivoted up, down, left or right relative to the housing.

According to another embodiment, the shaft of the insert is arranged concentric to and within the outer ring of the insert. The shaft is furthermore connected to the outer ring by multiple webs. A concentric or radially centered arrangement of the shaft within the outer ring also results in an approximate radially centered arrangement within the housing and within the flow channel formed by the housing. Since the slats preferably rest tightly against the outer side of the shaft in the open position, the slats are in their open position also effectively arranged centrally within the flow channel.

During the course of a transfer of the slats from the open position into the closed position, at least portions of the slats are moved radially outward in the direction of the outer ring. It is conceivable that the slats permanently rest against the outer side of the shaft with an inner edge and that an opposite outer edge of the slats comes in contact with the outer ring in the closed position. In the open position of the slats, the outer edge of each slat may likewise rest against the outer side of the shaft. The outer edge of each slat is displaced radially outward during the course of a transfer of the slat from the open position into the closed position.

Accordingly, the slats increasingly protrude into the flow cross section of the flow channel until they potentially close the flow channel completely or largely block the flow channel fluidically once they reach the closed position.

According to an enhancement, the webs and the outer ring form an abutment for the slat or slats. The abutment may feature a plane abutment surface or an abutment structure with a curved geometric shape. In this case, the longitudinally extending shaft axially protrudes from the abutment. In this respect, the longitudinal direction of the shaft may extend parallel to a surface normal of an abutment surface. Since the outer ring and the webs jointly form an abutment or abutment surface for the slats, the outer edges of individual slats can axially abut on at least one web, which typically extends in the radial direction, during the course of a transfer from the open position into the closed position.

Once such an abutment position is reached, the slats abutting on the web already are at least slightly aligned obliquely with reference to the axial direction or longitudinal extent of the shaft. As the transfer of the slat into the closed position continues, the outer edges of the slats abutting on the webs are guided further radially outward. In this respect, the webs form an axial abutment or limit stop for the slats. The outer edges of the slats may also be radially guided on the webs.

According to another embodiment, the shaft features at least one slot that extends in the longitudinal direction of the shaft. The shaft may extend in the axial direction. However, it may also have a directional component in the circumferential or tangential direction. The slat or slats arranged on the outer side of the shaft can be coupled or connected to the actuating element guided within the shaft through the at least one slot. If multiple slats are provided, the shaft is accordingly realized with multiple slots. The number and arrangement of the slots corresponds to the number of slats that are mechanically coupled to the actuating element.

According to another embodiment, the slat or slats are connected to the actuating element by a driving element. In this case, the driving element, which connects the slat and the actuating element to one another, extends through the slot in the shaft. In this respect, the driving element may act as a coupling element between the actuating element on the one hand and the slats on the other hand. For example, the driving element may be arranged in an articulated or pivotable fashion on at least either the slat or the actuating element. In this way, the slat or slats are able to carry out a pivoting motion relative to the actuating element.

According to an enhancement, the slat or slats provided respectively have an inner edge that corresponds to the outer circumference of the shaft. For example, the inner edge of the slat or slats may have a graduated circle geometry. In the closed position, a slat can rest against the outer side of the shaft in a sealing fashion along its entire inner edge.

According to another embodiment, an outer edge of the slats, which lies opposite of their inner edge, may also have a geometric extent that corresponds to the geometry of the outer ring. If the outer ring is realized circular, the outer edges of the slats may also have a corresponding graduated circular geometry. In the closed position, a slat can also rest against the outer ring in a sealing fashion along its entire outer edge. An excellent sealing effect can be achieved when the slats are in the closed position due to the geometric adaptation of the inner edges and outer edges of the slats to the outer circumference or to the outer side of the shaft, as well as to the geometry of the outer ring.

According to an enhancement of the air vent with multiple slats, circumferentially adjacent slats are arranged such that they at least sectionally overlap with their adjoining lateral edges. The individual slats may effectively lie on top of one another in an imbricated fashion similar to the segments of an iris diaphragm. However, it would also be conceivable to realize other configurations, in which both opposite lateral edges of a slat are covered by the respective edges of adjacent slats.

Vice-versa, the lateral edges of a slat may also cover the lateral edges of adjacent slats. The sectionally overlapping or covering arrangement of the lateral edges of adjacently arranged slats may furthermore form a mechanical coupling of sorts between the slats. For example, a motion of one slat can be transmitted to a slat arranged adjacent thereto by an at least sectional overlap. The lateral edges do not have to completely overlap in this case. The lateral edge of a slat may be provided, e.g., with a coupling element that protrudes from the lateral edge of the slat and overlaps with an adjacent slat.

According to an enhancement, a first lateral edge of each slat covers a second lateral edge of a circumferentially adjacent slat. In this case, the first lateral edge and the second lateral edge of the respective slats are opposite lateral edges. Consequently, an imbricated, overlapping and covering arrangement of individual slats is realized in the circumferential direction of the slat arrangement. The first lateral edge of the first slat covers a second lateral edge of the second slat. The first lateral edge of the second slat covers a second lateral edge of the third slat, etc., until the last slat once again covers the second lateral edge of the first slat with its first lateral edge.

The individual slats may be realized similar to a fan segment. The radially inner lateral edge of each slat, as well as a radially outer lateral edge thereof, may be realized in accordance with the curvature radius of the shaft and the outer ring. Viewed from the radial inner side toward the radial outer side, the opposite first and second lateral edges of each slat extend in a diverging fashion relative to one another. The first and second lateral edges typically extend in the radial direction. In a radially inner region, the distance between the first lateral edge and the second lateral edge is smaller than the distance between the first and the second lateral edge in a radially outer region. Those remarks respectively refer to the cylinder symmetry of the housing or to the cylinder symmetry of the shaft when the slats are in the closed position.

According to another embodiment, the actuating element protrudes from an outflow surface of the insert with an actuating end. In this way, it can be very easily controlled and is readily accessible to vehicle occupants. Since the actuating end of the longitudinally extending actuating element protrudes from an outflow surface of the insert or even from an outflow surface of the air vent, it can be directly taken hold of by an end user.

According to an enhancement, the actuating element furthermore features a pull/push rod that is guided in a longitudinally displaceable fashion in a guide. The guide is supported on an inner side of the shaft. The guide itself may in turn be guided in a longitudinally displaceable fashion in the shaft. It typically features a hollow-cylindrical sleeve, the inside diameter of which corresponds to the outside diameter of the pull/push rod. The guide may be guided in the shaft by an adjusting end and radially supported on the inner side of the shaft by the adjusting end. The adjusting end may be radially widened relative to the longitudinally extending and hollow-cylindrical sleeve. The guide, the pull/push rod and the shaft essentially extend parallel to one another.

The pull/push rod is furthermore mechanically coupled to the slat or slats. The pull/push rod is preferably coupled to multiple slats. The displacement of the pull/push rod relative to the guide results in the aforementioned combined translation and rotation of the slat or slats. A radially inner lateral edge of the slat typically is functionally connected to the pull/push rod. The guide and the shaft respectively feature at least one slot or through-opening, preferably multiple slots or through-openings that are distributed over the circumference. The driving element, which is connected to the at least one slat and to the pull/push rod, protrudes through the slots or through-openings.

The pull/push rod can initiate and control a corresponding adjusting motion of the slat or slats by carrying out a pulling and/or pushing motion relative to the housing and relative to the shaft or relative to the guide, i.e. by respectively carrying out a motion in the longitudinal direction of the pull/push rod or in the axial direction of the shaft.

According to an enhancement, the insert can be pivoted relative to the housing by the guide and/or by the actuating element. In particular, the guide is rigidly coupled to the insert or realized integrally with the shaft. Apart from its longitudinal displaceability in the guide, the pull/push rod may otherwise be connected to the insert in a largely rigid fashion.

According to an enhancement, the guide features a bearing section, which is pivotably arranged in a counter bearing section of an outflow element arranged on a longitudinal end of the housing on the outflow side. The bearing and counter bearing sections may form a ball joint of sorts, by which the guide is supported on the housing in the region of an outflow surface such that it can be pivoted about arbitrary pivoting axes and in arbitrary pivoting directions. Due to the longitudinally displaceable radial support of an adjusting end that lies opposite of the counter bearing section, the guide can directly transmit a pivoting motion to the insert.

A pivoting motion of the guide about a fulcrum or pivoting point that coincides with the adjusting end of the guide insofar leads to a correspondingly directed pivoting motion of the insert in the housing. This makes it possible to vary the direction of the air being discharged from the air vent.

The present disclosure also provides a motor vehicle having at least one of the above-described air vents in its interior.

### BRIEF DESCRIPTION OF THE DRAWINGS

The present disclosure will hereinafter be described in conjunction with the following drawing figures, wherein like numerals denote like elements.

FIG. 1 shows a side view of a motor vehicle;

FIG. 2 shows a perspective representation of an air vent suitable for the arrangement in the interior of a motor vehicle;

FIG. 3 shows a longitudinal cross section through the air vent according to FIG. 2 along the line A-A;

FIG. 4 shows an expanded view of the components arranged in or on the housing of the air vent according to FIG. 2;

FIG. 5 shows a cross section through the insert according to FIG. 2 along the line A-A, in which the slats arranged on the insert are in the closed position;

FIG. 6 shows a cross section similar to FIG. 5 with the slats in the open position;

FIG. 7 shows a perspective representation of the slats arranged on the shaft in the open position;

FIG. 8 shows a top view of the configuration according to FIG. 7;

FIG. 9 shows a perspective representation similar to FIG. 7 with the slats in the closed position;

FIG. 10 shows a top view of the slats according to FIG. 9;

FIG. 11 shows an isolated side view of an insert; and

FIG. 12 shows a top view of the insert according to FIG. 11 in the closed position viewed from the inner side of the vent.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

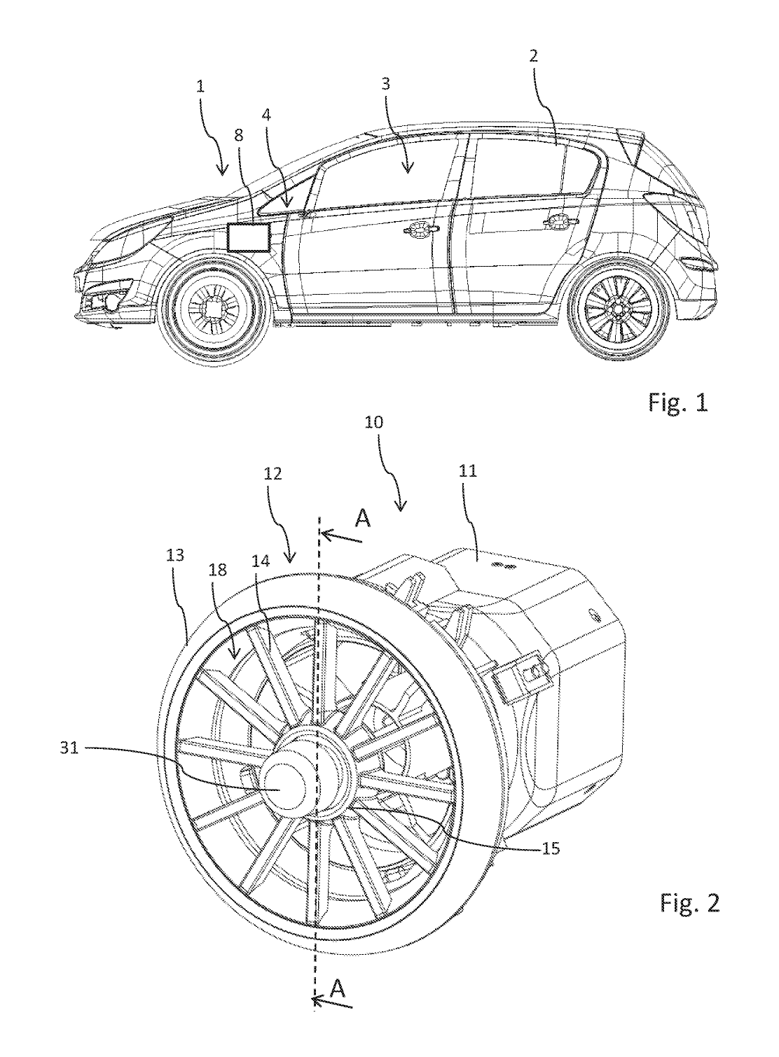

The motor vehicle schematically illustrated in FIG. 1 features an integral vehicle body 2, as well as an interior 3 that serves as an occupant compartment. Multiple seats for vehicle occupants are provided in the interior 3. In addition, multiple air vents 10 of the type illustrated in the form of a perspective representation in FIG. 2 are arranged in the interior 3, for example, in the region of a dashboard 4 that is merely indicated in FIG. 1. The air vent 10 features a housing 11 that forms a flow channel 5 for air supplied, for example, by a blower 8.

The air vent 10 is shown in its normal position in FIGS. 2-6 and features an outflow element 12 on an end 6 that lies on the outlet side, i.e. a downstream end. The outflow element 12 is presently realized in the form of a spoke rim of sorts. It features an approximately annular rim section 16, which corresponds to the inside geometry of the housing 11 and from which multiple webs 14 extend radially inward.

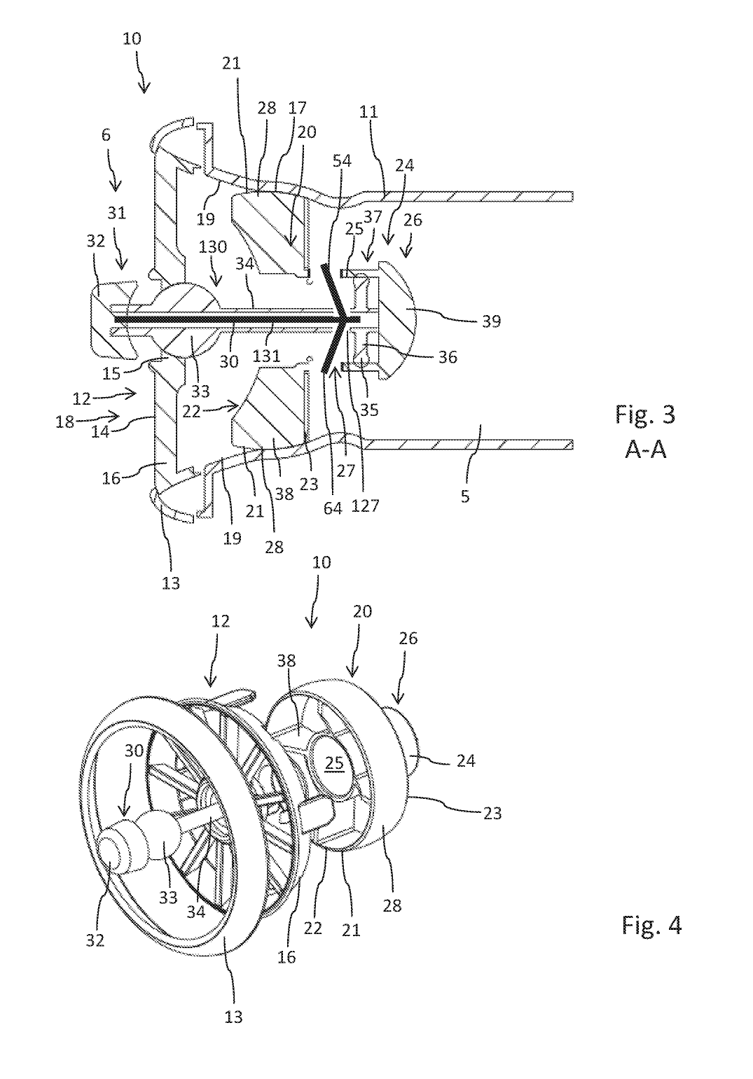

The inner ends of the webs 14 are connected to one another by a counter bearing 15. The counter bearing 15 is centrally arranged within the rim section 16. It effectively serves as hub of the spoke rim. In the installed position shown in FIG. 2, the counter bearing 15 is approximately arranged in the radial center of an outflow surface 18 of the air vent 10. A longitudinally extending guide 130 is pivotably supported on the counter bearing section 15 as illustrated, e.g., in FIG. 3.

An actuating end 31 is provided on the guide 130, which includes a hollow-cylindrical guide sleeve 34, and protrudes from the outer side of the outflow element 12. According to the cross-sectional representation in FIG. 3, this actuating end is provided with an actuating button 32. The actuating button 32 of the actuating end 31 is connected to an actuating element 30 featuring a pull/push rod 131, which is guided in a longitudinally displaceable fashion in the guide 130, particularly in its guide sleeve 34.

Adjacent to the actuating end 31, the guide 130 features a bearing section 33 that is pivotably supported in the counter bearing section 15 of the outflow element 12 and accordingly can be pivoted in any direction relative to the outflow element 12. The guide 130 features the longitudinally extending guide sleeve 34 in an extension of the actuating end 31, but on an opposite, inwardly directed side of the bearing section 33.

A radially widened abutment ring 35 is arranged on an adjusting end 37 of the guide 130, which lies opposite of the actuating end 31. The abutment ring 35 is connected to the guide sleeve 34 by multiple radially extending webs. The adjusting end 37 may also feature an air-impermeable disk, which is radially widened relative to the rod section 34, instead of multiple webs 36. In the embodiment according to FIG. 3, the rear end 26 of the shaft 24, which lies in the interior of the housing, is closed with an end cap 39. The end cap 39 is air-impermeable and prevents supplied air from flowing through the shaft 24.

According to FIG. 3, the guide sleeve 34 and therefore the adjusting end 37 have a greater longitudinal extent than the actuating end 31 of the guide 130. The guide 130 extends through the outflow element 12 in the longitudinal direction, i.e. in the direction of the flow channel 5, and is pivotably supported on the outflow element 12 in the region of the bearing section 33, which lies relatively close to the actuating end 31. As a result, a comparatively slight pivoting motion or adjusting motion of the actuating end 31 and the guide 130 coupled thereto leads to a relatively extensive adjusting or pivoting motion of the adjusting end 37, as well as a corresponding pivoting motion of the insert relative to the housing 11 associated herewith.

The bearing section 33 may be realized in the form of a spherical segment. The correspondingly designed counter bearing section 15 of the outflow element 12 may feature a spherical socket. In this way, the guide 130 can be pivoted in any radial direction relative to the longitudinal extent of the housing 11, e.g., by the actuating element 30 and its actuating end 31.

In the presently described embodiment, the outflow element 12 may serve as a design element or decorative element. It may have a spoke-like or wheel-like geometry as shown in the figures. However, completely different air-permeable geometric shapes of the outflow element 12 may be adapted as the outflow element 12. The outflow element 12 can be fastened on the longitudinal end 6 of the housing 11 of the vent 10 by a peripheral annular rim 13. For example, it may be clipped on the housing 11 by the rim 13.

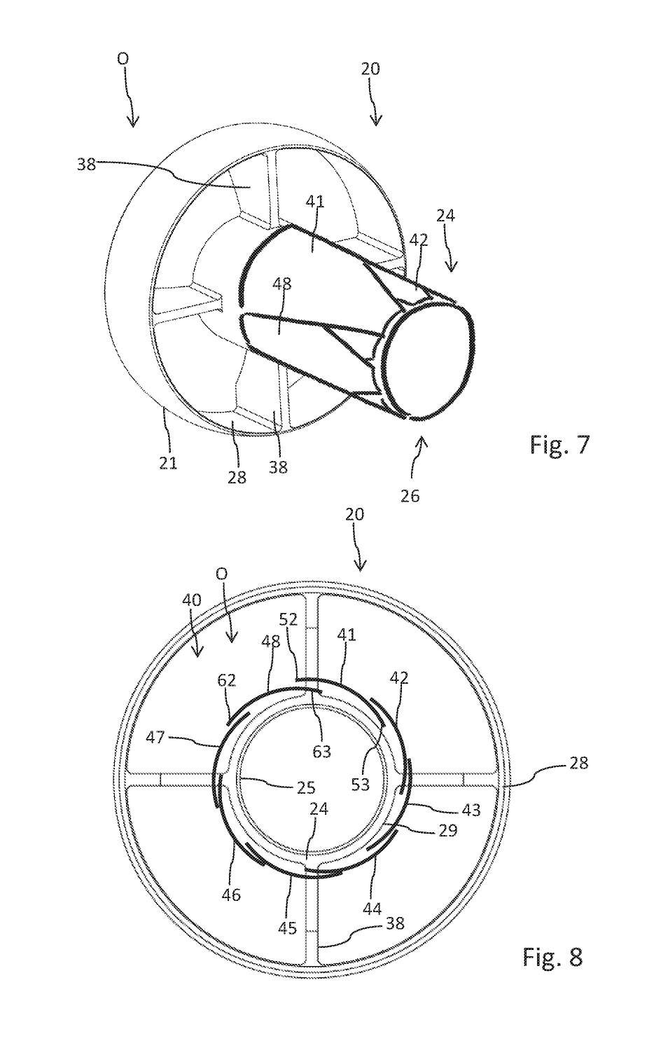

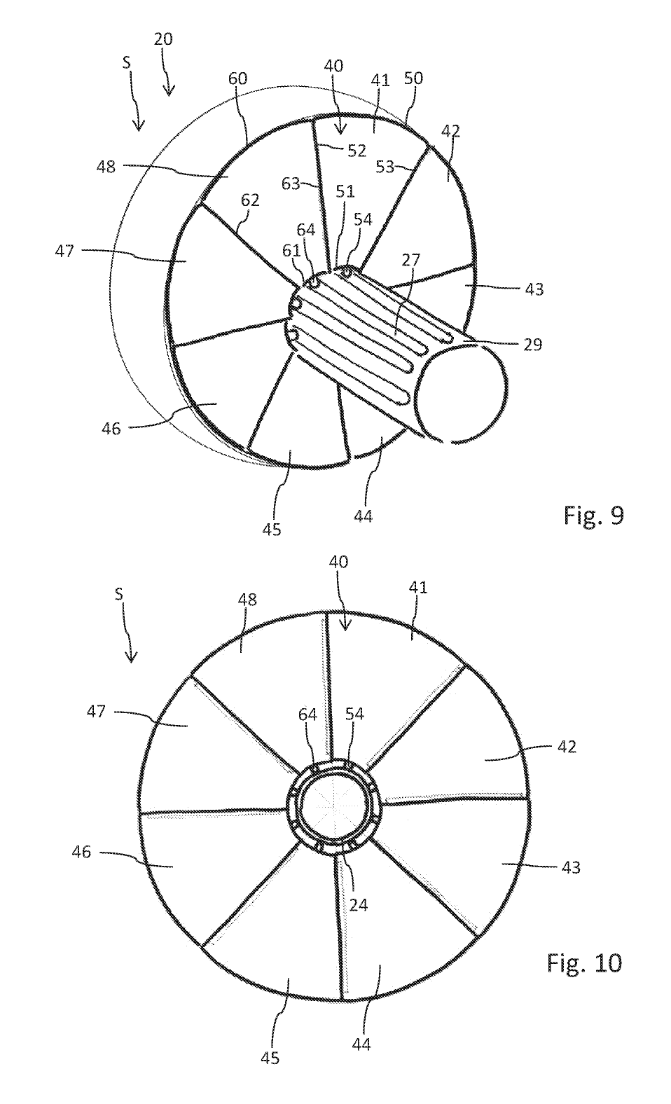

The insert 20 illustrated in the form of a perspective representation in FIGS. 7 and 9 features an annular and closed outer ring 28 which preferably has a curved outer surface 21. It is realized corresponding to the concave curvature section 17 on the inner wall 7 of the housing 11. The curvature section 17 and the corresponding outer surface 21 may also be realized in the form of spherical segments. The curvature section 17 may be at least partially realized in the form of a joint socket or spherical socket whereas the outer surface 21 is realized in the form of a spherical segment.

The mutually adapted geometric shapes of the outer surface 21 and the curvature section 17 make it possible to arbitrarily pivot the insert 20 relative to the rigid housing 11. The hollow-cylindrical housing 11 features a bevel 19, which widens radially outward, longitudinally adjacent to the curvature section 17 and toward the outflow element 12. In the extreme position of the insert 20 according to FIG. 7, this bevel 19 is approximately aligned with the outer section 27 and the air guiding element formed thereby.

In a downwardly directed end position of the insert 20, a largely turbulence-free flow of the air being discharged from the air vent 10 is thereby achieved. The bevel 19 is typically realized radially symmetrical. It can be regarded, for example, as a conical widening of sorts of the inner wall 7 toward the outflow surface 18.

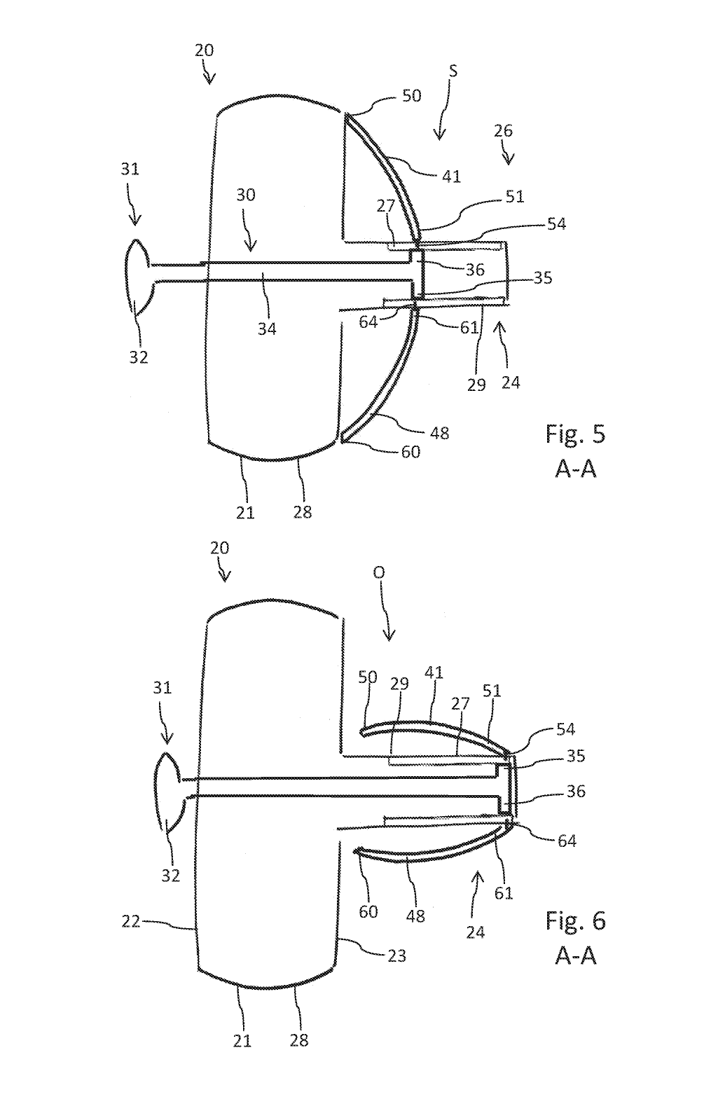

The shaft 24 is arranged within the outer ring concentric to the outer ring 28. The shaft 24 is realized hollow-cylindrical. Multiple slats 41, 42, 43, 44, 45, 46, 47, 48 are located on an outer side 29 of the shaft 24 and supported on the shaft 24 such that they can be selectively moved between a closed position S according to FIGS. 5, 9 and 10 and an open position O according to FIGS. 6, 7 and 8.

The shaft 24 has a greater extent in the axial or longitudinal direction than the outer ring 28 of the insert 20. The outer ring 28 and the shaft 24 may be integrally connected to one another. In this context, the entire insert 20 may be realized integrally except for the slats 41, 42, 43, 44, 45, 46, 47, 48 arranged thereon. The shaft 24 is connected to the outer ring 28 by multiple webs 28. The webs 28 are distributed over the circumference of the shaft 24. They respectively extend radially outward from the shaft 24 and are connected to an inner side of the outer ring 28.

The longitudinally extending actuating element 30 is guided in a longitudinally displaceable fashion within the longitudinally extending shaft 24. The actuating element 30, particularly its pull/push rod 131, features an actuating end 31 with an actuating button 32, which protrudes from a front side 22 of the insert 20 in the longitudinal direction or in the axial direction, respectively. The longitudinally extending guide sleeve 34 is connected to the actuating end 31. An opposite end of the guide sleeve 34 features at least one driving element 54, 64 that protrudes radially outward and is mechanically coupled to the at least one slat 41, 42, 43, 44, 45, 46, 47, 48.

The guide 130 is guided in a sliding fashion on an inner side 25 of the shaft 24 by the radially widened ring section 35. According to FIGS. 6 and 9, the shaft 24 features multiple longitudinal slots 27 that extend through the entire sidewall of the shaft 24. The actuating element 30 can be mechanically coupled to the slats 41, 42, 43, 44, 45, 46, 47, 48 through these slots 27 or openings in the sidewall of the shaft 24. The mechanical coupling could also be realized, for example, by respectively providing driving elements 54, 64 in the form of projections, which protrude radially inward, on the inner edges 51, 61 of the slats 41, 48. The individual slots 27 distributed over the circumference of the shaft 24 extend parallel to one another.

Longitudinally extending slots 127 are likewise provided in the guide such that they correspond to the slots 27 in the shaft 24. The mechanical coupling between the actuating element 30 and the slat 41 extends through the slot 127, as well as through the slot 27. The driving elements 54, 64 protrude through the respective slots 27, 127 in the sidewalls of the guide sleeve 34 and the shaft 24. The driving elements 54, 64 may be directly connected to the pull/push rod 131 of the actuating element 30. It is conceivable that the actuating element 30 features an interlocking structure that can be connected to the driving elements 54, 64. The driving elements 64, 54 may also be integrally connected to the actuating element 30 and protrude outward through the slots 27, 127 in order to cooperate with the inner edges 51, 61 of the slats 41, 48 and thereby displace these slats in the axial direction.

Only the slats 41, 48 and their mechanical coupling to the actuating element 30 are discussed below in a representative fashion for all slats simply for illustrative purposes. The corresponding description applies accordingly to the remaining slats 42, 43, 44, 45, 46, 47. However, the slat arrangement 40 formed by the slats 41, 42, 43, 44, 45, 46, 47, 48 is not limited to the implementation of eight slats. In principle, the implementation of only a single slat already suffices for the functionality of the air vent 10. The overall number of slats can also vary in accordance with specific requirements. The air vent 10 may feature far more, but also far fewer than the eight slats provided in the exemplary embodiment. The slat arrangement 40 presently serves as a throttle device for throttling an air flow.

The slats 41, 48 are air-impermeable. In their open position O illustrated, for example, in FIGS. 7 and 8, they largely rest against the outer side 29 of the shaft 24 with their entire surface. In this case, the flow cross section of the flow channel 5, through which air can flow, is adjusted to its maximum. The individual slats 41, 48 tightly rest against the outer side 29 of the shaft 24 such that they partially overlap or cover one another. According to FIG. 6, the outer edges 50, 60 of the slats 41, 48 are axially spaced apart from an abutment 23 or abutment surface on the rear side of the insert 20.

The abutment 23 is formed by the webs 38 and by the outer ring 28. Starting from the open position illustrated in FIG. 6, the actuating element 30 can be pulled toward the left, i.e. in the axial direction and outward in the flow direction of the air vent 10. Due to the direct or indirect mechanical coupling of the actuating element 30 to all slats 41, 48, such a pulling motion causes the respective slat 41, 48 to carry out a corresponding leftward or distal motion in the flow direction.

During the course of this distal motion, the outer edges 50, 60 come in contact with at least one of the webs 38. Since the slats 41, 48 are pre-curved or slightly inclined relative to the axial or longitudinal extent of the shaft 24 as indicated in FIG. 6, the slats 41, 48 are supported on the webs 38 in such a way that they are pivoted radially outward with their outer edges 50, 60 as the motion in the distal direction continues. The inner edges 51, 61 respectively are pivotably connected to the shaft 24 and to the actuating element 30 such that all slats 41, 48 carry out a combined translation and rotation or pivoting motion during a transfer from the open position O into the closed position according to FIG. 5.

The outer edges 50, 60 of the slats 41, 48 abut on the outer ring 28 when the closed position S illustrated in FIG. 5 is reached. In this configuration, almost the entire flow cross section of the flow channel 5 is fluidically blocked by the extended slats 41, 48.

The illustration according to FIG. 9 shows that the adjacently arranged slats 41, 48 at least sectionally cover one another. The slat 41 has a left lateral edge 52 and an opposite right lateral edge 53. The slat 48 arranged adjacent thereto on the left likewise has a left lateral edge 62 and a right lateral edge 63. In this context, it is proposed that the first lateral edge 52 of the slat 41 covers the second lateral edge 63 of the adjacently arranged slat 48. However, the opposite lateral edge, i.e. the second lateral edge 53 of the slat 41, is covered by the lateral edge of the adjacently arranged slat 42.

In the illustrations according to FIGS. 9 and 10, all right lateral edges of the slats 41, 48 therefore are respectively covered by the left lateral edge of a slat arranged adjacent thereto on the right. The left lateral edges of all slats 41, 48 cover a right lateral edge of a slat arranged adjacent thereto on the left.

In this respect, an imbricated circumferential and mutual overlap of slats 41, 48 arranged adjacent to one another in the circumferential direction is achieved. Since the slats 41, 48 particularly have a significantly greater extent in the tangential or circumferential direction on the radially outer side, i.e. in the vicinity of the outer edges 50, 60, than on the radially inner edge 51, the slats 41, 48 can be arranged such that they tightly rest against the shaft 24 due to the at least sectional overlap of slats 41, 48 in order to thereby maximize the free flow cross section of the flow channel 5.

The longitudinally extending actuating element 30 may not only be guided on the insert 20 or on the outflow element 12 in the region of a rear end of the shaft 24, which protrudes from the abutment 23 on the rear side, but also in the region of the front side 22 of the insert 20. In this respect, the actuating element 30 is advantageously supported in the guide 30 such that it can be displaced in a sliding motion or translation only. A pivoting motion of the actuating element 30 caused by the actuating end 31 can be transmitted to the guide 130 due to the longitudinal guidance in the guide sleeve 34 and to the insert 20 due to the support by the abutment ring 35. The insert 20 can insofar be pivoted relative to the housing 11 by the actuating element 30.

An adjusting motion of the slats 41, 48 can be simultaneously initiated and controlled by pulling out the actuating element 30 from the insert 20 or pushing the actuating element into the insert 20. In this way, the air flow being discharged from the air vent 10 can be varied with respect to its direction, as well as with respect to its intensity or outflow characteristic, by the actuating element 30. The actuating element 30 therefore serves as a multifunctional control element for the air vent. All in all, the number of components required for realizing the air vent can be reduced. This in turn makes it possible to reduce the weight, as well as the manufacturing and assembly costs.

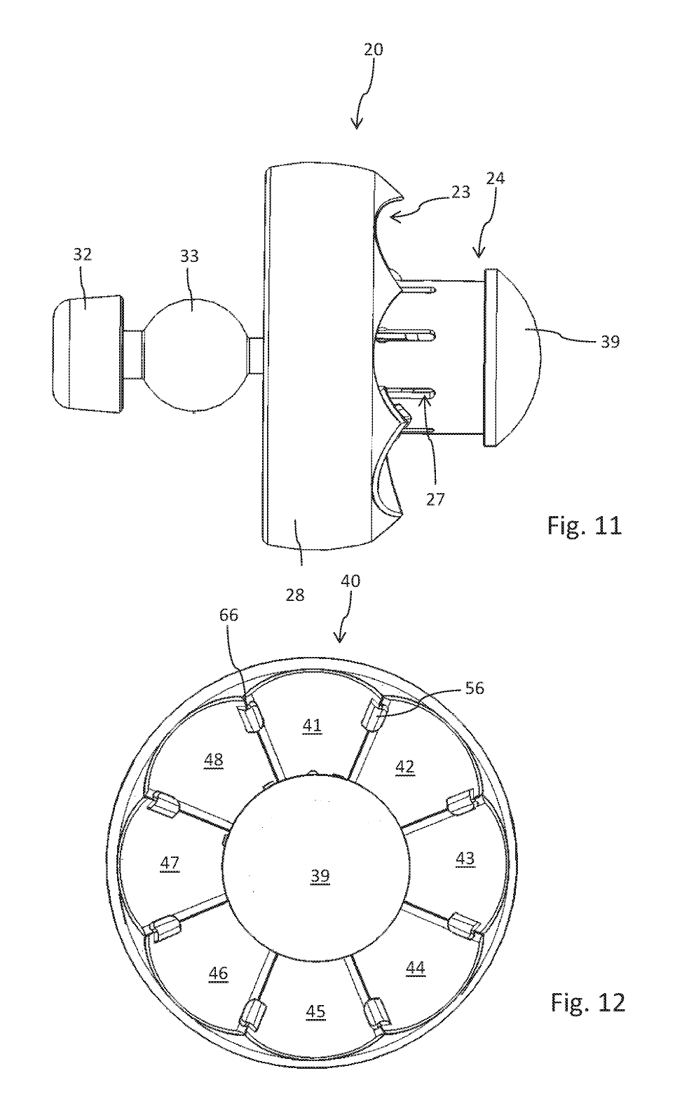

FIGS. 11 and 12 show a slight modification of the air vent. In this case, the individual slats 41, 42, 43, 44, 45, 46, 47 and 48 are not realized flat or plane, but rather curved. Accordingly, the abutment 23 has a corrugated structure in the region of the outer ring 28, against which the slats 41, 48 rest in a sealing fashion in the closed position S. In this case, the outer ring respectively features a concavely curved section for each of the slats 41, 48.

The illustration of the closed position of the slats 41, 48 according to FIG. 12 furthermore shows individual coupling elements 55, 56, which respectively protrude from a lateral edge of a slat 41, 48 in the tangential or circumferential direction and overlap with the adjacent slat. A few or even all slats 41, 48 can be mechanically coupled to one another by such coupling elements 56, 66. The connection of a single slat 41 or of two opposite slats 41, 45 to the actuating element 30 may already suffice for realizing the motion of the slats 41, 48 between the open position and the closed position.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. An air vent comprising:
a longitudinally extending housing having a flow channel with a flow cross section;
an insert disposed in the housing and extending over the flow cross section;
a longitudinally extending hollow shaft arranged on the insert;
an actuating element guided in a longitudinally displaceable fashion in the shaft; and
at least one slat arranged on an outer side of the shaft and connected to the actuating element.

17. The air vent according to claim 16, wherein the at least one slat is supported on the shaft such that the slat is movable between an open position such that the slat rests against an outer side of the shaft, and a closed position such that the slat protrudes from the shaft into the flow channel.

18. The air vent according to claim 16, further comprising a plurality of slats distributed over an outer circumference of the shaft, each slat guided in a longitudinally displaceable manner between an open position and a closed position along the shaft.

19. The air vent according to claim 16, wherein the insert comprises an outer ring resting against an inner wall of the housing.

20. The air vent according to claim 19, wherein the outer ring comprises a curved outer surface that is pivotably supported on a complementarily curvature section of the inner wall of the housing.

21. The air vent according to claim 19, wherein the shaft is concentric to and positioned within the outer ring and connected to the outer ring by a plurality of webs.

22. The air vent according to claim 22, further comprising an abutment for the slat formed by the webs and the outer ring, wherein the shaft protrudes from the abutment.

23. The air vent according to claim 16, wherein the shaft comprises at least one slot extending in the longitudinal direction of the shaft.

24. The air vent according to claim 23, further comprising a driving element extending through the slot and connecting the slat to the actuating element.

25. The air vent according to claim 24, wherein the slat has an inner edge corresponding to the outer circumference of the shaft.

26. The air vent according to claim 25, further comprising a plurality of circumferentially adjacent slats at least sectionally overlapping with an adjoining lateral edge.

27. The air vent according to claim 26, wherein a first lateral edge of each slat covers a second lateral edge of a circumferentially adjacent slat, wherein the first lateral edge and the second lateral edge are opposite edges of a respective slat.

28. The air vent according to claim 16, wherein the actuating element comprises a pull/push rod guided in a guide supported on an inner side of the shaft in a longitudinally displaceable fashion.

29. The air vent according to claim 28, wherein the guide comprises a bearing section pivotably arranged in a counter bearing section of an outflow element, which is arranged on a longitudinal end of the housing on the outflow side.

30. A motor vehicle comprising a vehicle body defining an interior occupant compartment with a dashboard, and at least one air vent according to claim 16 disposed in the dashboard and in fluid communication with a blower.

31. An air vent comprising:
a longitudinally extending housing having a flow channel with a flow cross section;
an insert disposed in the housing and extending over the flow cross section wherein the insert includes an outer ring having a curved outer surface that is pivotably supported on a complementarily curvature section of the inner wall of the housing;
a longitudinally extending hollow shaft arranged on the insert at least one slot extending in the longitudinal direction;
an actuating element guided in a longitudinally displaceable fashion in the shaft;
a driving element extending through the slot and connecting the slat to the actuating element; and
at least one slat arranged on an outer side of the shaft and connected to the actuating element, wherein the slat is supported on the shaft such that the slat is movable between an open position such that the slat rests against an outer side of the shaft, and a closed position such that the slat protrudes from the shaft into the flow channel.

32. The air vent according to claim 31, further comprising a plurality of slats distributed over an outer circumference of the shaft, each slat guided in a longitudinally displaceable manner between an open position and a closed position along the shaft.

33. The air vent according to claim 31, further comprising a plurality of webs connected to the outer ring and extending inwardly to concentrically position the shaft within the outer ring, and an abutment for the slat formed by the webs and the outer ring, wherein the shaft protrudes from the abutment.

34. The air vent according to claim 33, further comprising a plurality of circumferentially adjacent slats at least sectionally overlapping with an adjoining lateral edge, wherein each slat has a first lateral edge and a second lateral edge opposite the first lateral edge, and the first lateral edge of each slat covers a second lateral edge of a circumferentially adjacent slat.

35. The air vent according to claim 31, wherein the guide comprises a bearing section pivotably arranged in a counter bearing section of an outflow element, which is arranged on a longitudinal end of the housing on the outflow side.
